(19) United States
(12) Patent Application Publication
(10) Pub. No.: US 2015/0379455 A1
(43) Pub. Date: Dec. 31, 2015

(54) PROJECT PLANNING AND IMPLEMENTING

(71) Applicant: Authoria, Inc., Waltham, MA (US)

(72) Inventors: Mark Lawrence Munzer, Waltham, MA (US); Hannah Elizabeth Liberty, Waltham, MA (US); Mark Edelsberg, Palo Alto, CA (US)

(21) Appl. No.: 14/319,108

(22) Filed: Jun. 30, 2014

(51) Int. Cl. G06Q 10/06; G06F 3/0484

(52) U.S. Cl. CPC G06Q 10/063114; G06F 3/04847; G06F 3/04842

(57) ABSTRACT

Among other things, we describe receiving project ideas from multiple people, each of the project ideas having a corresponding status, presenting to a user through a user interface the project ideas in a grid showing project labels identifying the project ideas, the project ideas being grouped by the corresponding status, and enabling the user to dynamically change the corresponding status of at least one of the project ideas by moving a corresponding project label in the grid.

### BACKGROUND

This description relates to project planning and implementing.

An entity may perform various project planning and implementing processes, for example, to help ensure that the activities for a project are completed.

### SUMMARY

The electronic communicating that we describe here may encompass one or more of the following (and other) aspects, features, and implementations, and combinations of them.

In general, in an aspect, a method includes, for an organization or entity that engages in projects through people who are associated with the organization or entity, each of the people or the projects or both being managed by users who are also associated with the organization or entity presenting through a user interface a representation for each of at least one aspect of one or more of the projects, another representation of a status of each of the aspects, and a relationship between each of the aspects and the corresponding status of the aspect, the relationship being represented by stored data, each aspect being assigned to at least one of the people, and enabling one of the users to manage at least one of the people or at least one of the aspects or both by manipulating the user interface to change the relationship represented by the stored data.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of this aspect may include one or more of the following features. The stored data may identify one or more people assigned to each of the aspects, and the one of the users is a manager of the people. The stored data may identify projects that are active. The stored data may identify projects that are proposed but not active. The method may include receiving, for at least one of the proposed projects, a rating of the corresponding proposed project. The method may include ranking at least some of the projects using the corresponding ratings, and in which presenting through the user interface the representation for each of the at least one aspect of one or more of the projects, the other representation of the status of each of the aspects, and the relationship between each of the aspects and the corresponding status of the aspect includes presenting a representation of an aspect for each of two or more of the ranked projects according to the ranking. The method may include aggregating, for at least one of the rated projects, the corresponding ratings.

In some implementations, the stored data may identify the status for each of the aspects of the one or more of the projects. The stored data may identify a task as a particular aspect of one of the projects and a person assigned to the task. The representation of the particular aspect may identify the task and the representation of the corresponding status of the particular aspect may identify the person assigned to the task. Presenting through the user interface the representation for each of at least one aspect of one or more of the projects, the other representation of the status of each of the aspects, and the relationship between each of the aspects and the corresponding status of the aspect may include presenting the representations and the other representations in a grid, the columns or the rows of which identify the relationships between each of the aspects and the corresponding statuses of the aspects. Enabling the one of the users to manage at least one of the people or at least one of the aspects or both by manipulating the user interface to change the relationship represented by the stored data may include enabling the user to move at least one of the representations or at least one of the other representations from one cell of the grid to another cell of the grid within the user interface. Presenting the representations and the other representations in the grid may include presenting the representations and the other representations in the grid in which a position of each of the other representations of the statuses remains constant while enabling the one of the users to dynamically change a position of at least one of the representations of an aspect.

In some implementations, each of the other representations may identify a person assigned to a corresponding aspect of the projects represented by the representation of the corresponding aspect, and presenting the representations and the other representations may include presenting the representations and the other representations in the grid with multiple representations for the same aspect of one of the projects each of which associate the corresponding aspect with a different person assigned to the corresponding aspect. The stored data may be stored in a database. The method may include receiving indication of a change to the stored data by the one of the users, and automatically updating the stored data in the database in response to receipt of the indication of the change to the stored data by the one of the users. A position of one of the representations or one of the other representations, with respect to another representation in the user interface, may indicate a priority of the corresponding representation or the corresponding other representation. Enabling the user to manage at least one of the people or at least one of the aspects or both by manipulating the user interface to change the relationship represented by the stored data may include enabling the user to change the priority of the corresponding representation or the corresponding other representation by moving the corresponding representation or the corresponding other representation within the user interface.

In some implementations, the method may include identifying a subset of the aspects that are assigned to the user. Presenting through the user interface the representation for each of at least one aspect of one or more of the projects, the other representation of the status of each of the aspects, and the relationship between each of the aspects and the corresponding status of the aspect may include presenting only the representations and the other representations for the identified subset of the aspects. The method may include determining an active, complete, planned, or proposed status of each of the projects, and in which presenting through the user interface the representation for each of at least one aspect of one or more of the projects, the other representation of the status of each of the aspects, and the relationship between each of the aspects and the corresponding status of the aspect includes presenting a representation of at least one aspect of one or more active or planned projects. The method may include determining an active, complete, planned, or proposed status of each of the projects. Presenting through the user interface the representation for each of at least one aspect of one or more of the projects, the other representation of the status of each of the aspects, and the relationship between each of the aspects and the corresponding status of the aspect may include presenting a representation of at least one aspect of one or more proposed projects.

In some implementations, the method may include receiving, from the user, identification of one or more rules for the projects. Presenting through the user interface the representation for each of at least one aspect of one or more of the projects, the other representation of the status of each of the aspects, and the relationship between each of the aspects and the corresponding status of the aspect may include applying the rules to the representations or the other representations and presenting the representations and the other representations to which the rules have been applied. One of the rules may exclude at least one of the representations or one of the other representations from the user interface. One of the rules may distinguish at least one of the representations or one of the other representations from the remaining representations.

In some implementations, the method may include receiving selection of one of the representations or one of the other representations, and presenting additional details about the corresponding aspect that corresponds to the selected representation or the corresponding status that corresponds to the selected other representation. The method may include enabling the user to invoke social features for the corresponding aspect or the corresponding status. Enabling the user to invoke social features may include enabling the user to communicate with another user about the corresponding aspect or the corresponding status. The method may include enabling the user to invoke video features for the corresponding aspect or the corresponding status. Enabling the user to invoke video features may include receiving, from a device operated by the user or a party other than the user, video information capturing a video presentation about the corresponding aspect or the corresponding status. Enabling the user to invoke video features may include providing a video presentation about the corresponding aspect or the corresponding status to the user through a user interface.

These and other aspects, features, and implementations, and combinations of them, may be expressed as apparatus, methods, methods of doing business, means or steps for performing functions, components, systems, program products, and in other ways.

In general, in an aspect, a method includes receiving information that identifies people assigned to work on a project and tasks assigned to the people to complete the project, presenting the project to a user through a user interface, as a grid showing name labels identifying the people assigned to work on the project and task labels associating the tasks with the people to whom the tasks are assigned, and enabling the user to dynamically change the people to whom one or more of the tasks are assigned by moving a corresponding name label or a corresponding task label in the grid, or dynamically change the visual representation of a priority of a task by moving a corresponding task label, or both.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of this aspect may include one or more of the following features. The information that identifies the people and the tasks may be stored in a database, and when the user dynamically changes the people to whom one or more of the tasks are assigned or the task priority, the information in the database may be automatically changed. The user may be a manager of the people. The method may include identifying a subset of the tasks that are assigned to the user, and in which presenting the project in the grid includes presenting only the identified subset of the tasks in the grid. The method may include determining an active, complete, or planned status of each of the tasks, and in which presenting the project in the grid includes presenting currently active tasks and planned tasks in the grid.

In some implementations, the method may include receiving, from the user, identification of one or more rules for presenting the project, and in which presenting the project in the grid includes applying the rules to the grid and presenting the grid to which the rules have been applied. One of the rules may exclude at least one of the tasks or the people from the grid. One of the rules may identify at least one of the tasks or at least one of the people for highlighting in the grid. The method may include receiving selection of one of the tasks or one of the people, and presenting additional details about the selected task or the selected person. The method may include enabling the user to invoke social features for the selected task or the selected person. Enabling the user to invoke social features may include enabling the user to communicate with another user about the selected task or the selected person.

In some implementations, the method may include enabling the user to invoke video features for the selected task or the selected person. Enabling the user to interact with video features may include receiving, from a device operated by the user or a party other than the user, video information capturing a video presentation about the selected task or the selected person. Enabling the user to interact with video features may include providing a video presentation about the selected task or the selected person to the user, through a user interface. Presenting the project may include presenting the project in the grid in which a position of each of the name labels remains constant while enabling the user to dynamically change a position of at least one of the task labels. Presenting the project may include presenting the project in the grid with multiple identifiers for a single task label each of which associate the single task label with a different name label.

These and other aspects, features, and implementations, and combinations of them, may be expressed as apparatus, methods, methods of doing business, means or steps for performing functions, components, systems, program products, and in other ways.

In general, in an aspect, a method includes receiving project ideas from multiple people, each of the project ideas having a corresponding status, presenting to a user through a user interface the project ideas in a grid showing project labels identifying the project ideas, the project ideas being grouped by the corresponding status, and enabling the user to dynamically change the corresponding status of at least one of the project ideas by moving a corresponding project label in the grid.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of this aspect may include one or more of the following features. All of the multiple people may be employed by an entity and the project ideas are for the entity. The user may be a manager of the people. The method may include receiving, from at least one of the people, a rating of one or more of the project ideas. The method may include ranking at least some of the project ideas using corresponding ratings, and in which presenting the project ideas in the grid includes presenting the ranked project ideas in the grid according to the ranking. The method may include aggregating, for at least one of the project ideas, the corresponding ratings received from the people.

In some implementations, the method may include receiving selection of one of the project ideas, and presenting additional details about the selected project idea. The method may include enabling the user to interact with social features for the selected project idea. Enabling the user to interact with social features may include enabling the user to communicate with another user about the selected project idea. The method may include enabling the user to interact with video features for the selected project idea. Enabling the user to interact with video features may include providing a video presentation about the selected project idea to the user. Receiving at least one of the project ideas may include receiving, from a device operated by the user or a party other than the user, video information capturing a video presentation about the corresponding project idea.

These and other aspects, features, and implementations, and combinations of them, may be expressed as apparatus, methods, methods of doing business, means or steps for performing functions, components, systems, program products, and in other ways.

The subject matter described in this specification can be implemented in particular embodiments so as to realize one or more of the following advantages. In some implementations, a system automatically updates status information, e.g., project assignments, or a proposed, planned, active, or complete status, for a project in response to a change in a project label or a status label that graphically present information about the project. In some implementations, a system receives and tabulates votes for project ideas and automatically determines a project idea with the most votes, e.g., that may be implemented by an entity. In some implementations, social and video features provide a user with a more interactive experience, e.g., when viewing details about a project, a task, or a project idea.

Other aspects, features, and advantages will be apparent from the description and the claims.

### DESCRIPTION

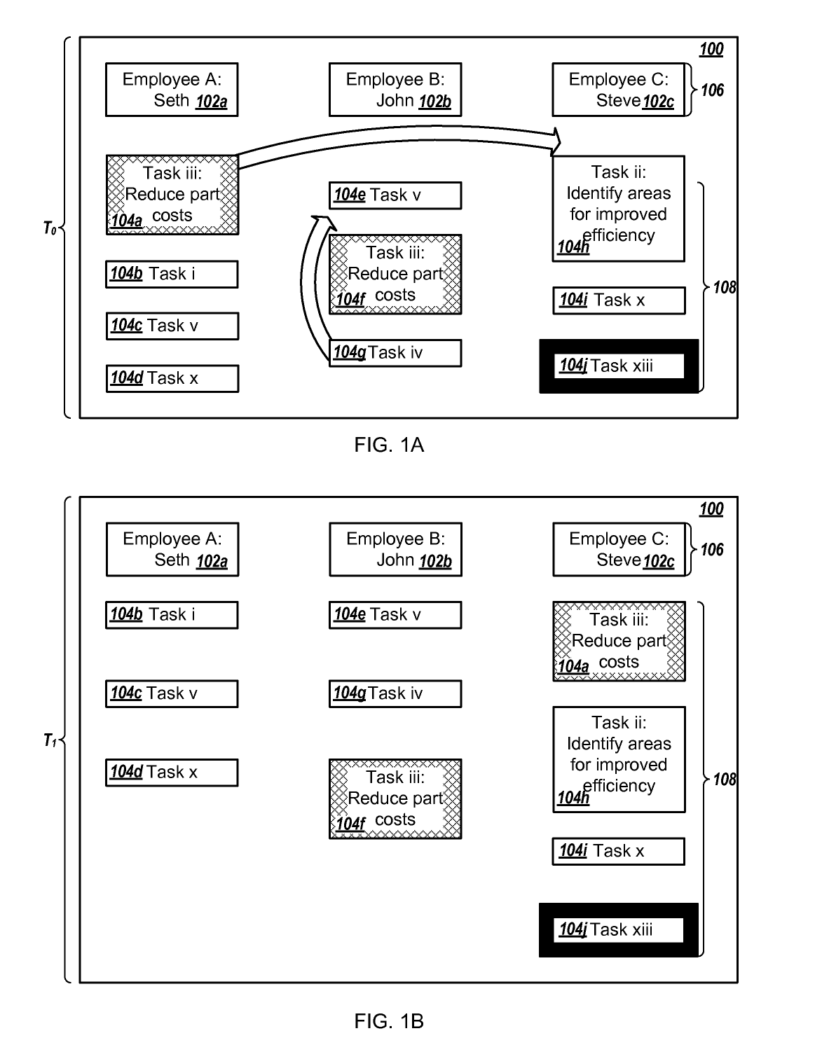

FIGS. 1A-B show an example of a project planning user interface.

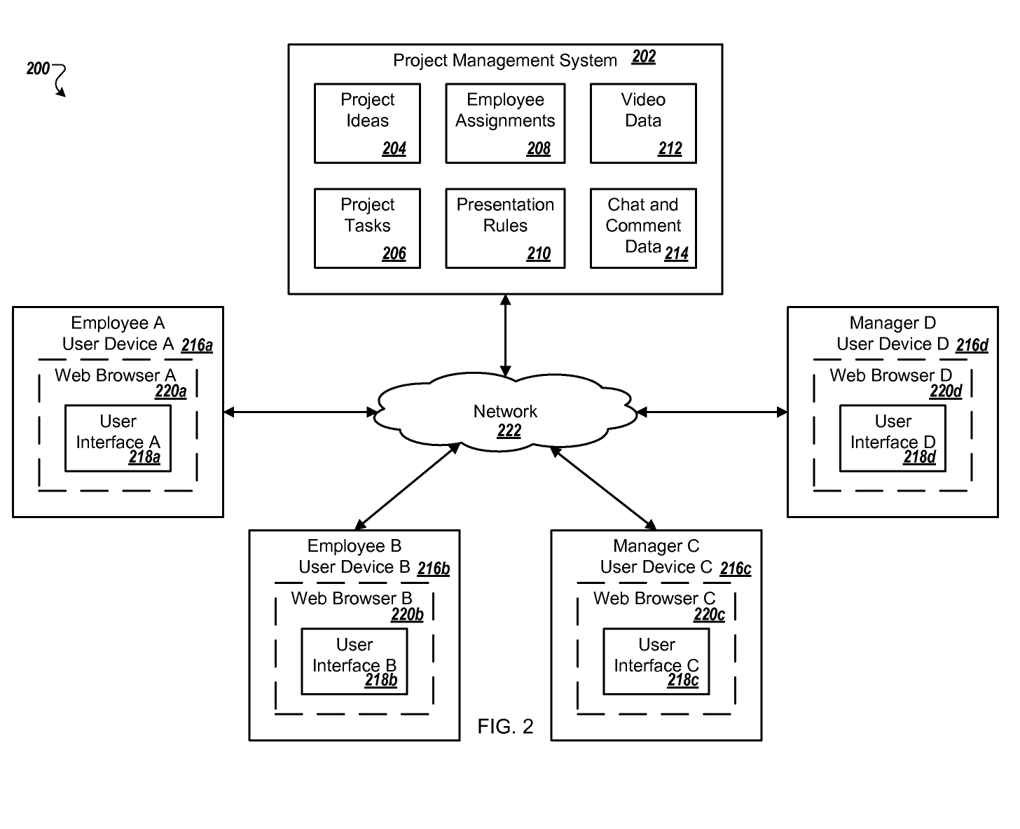

FIG. 2 is a block diagram of an example environment in which a project management system provides information for a project planning user interface to a user device upon request.

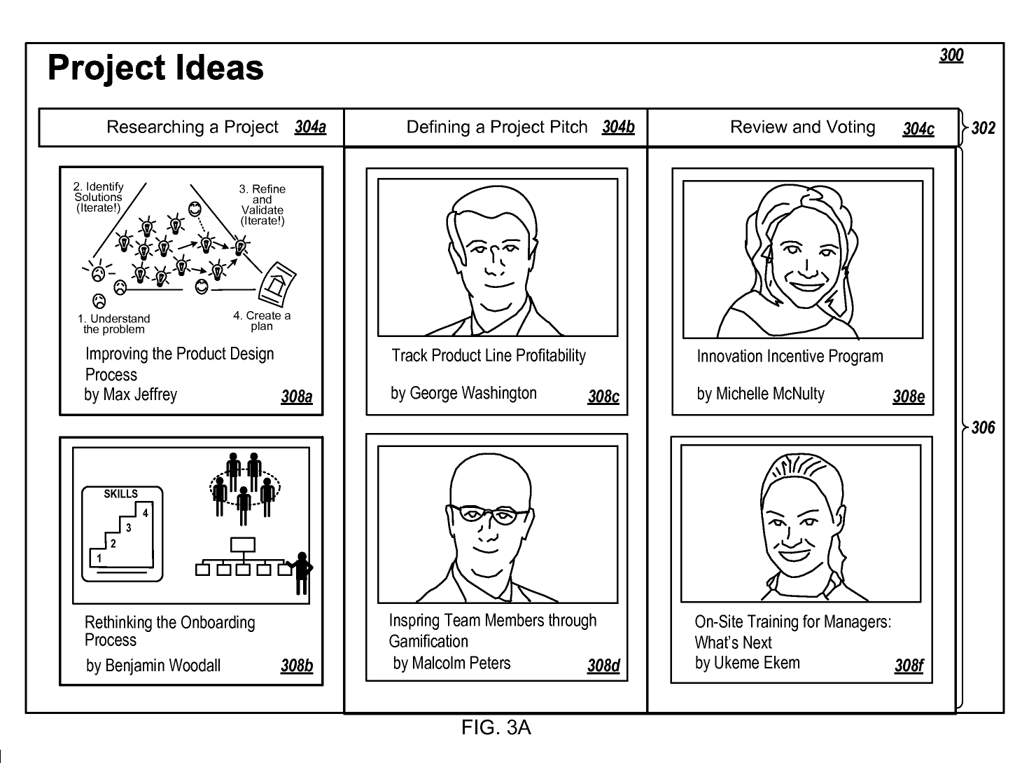

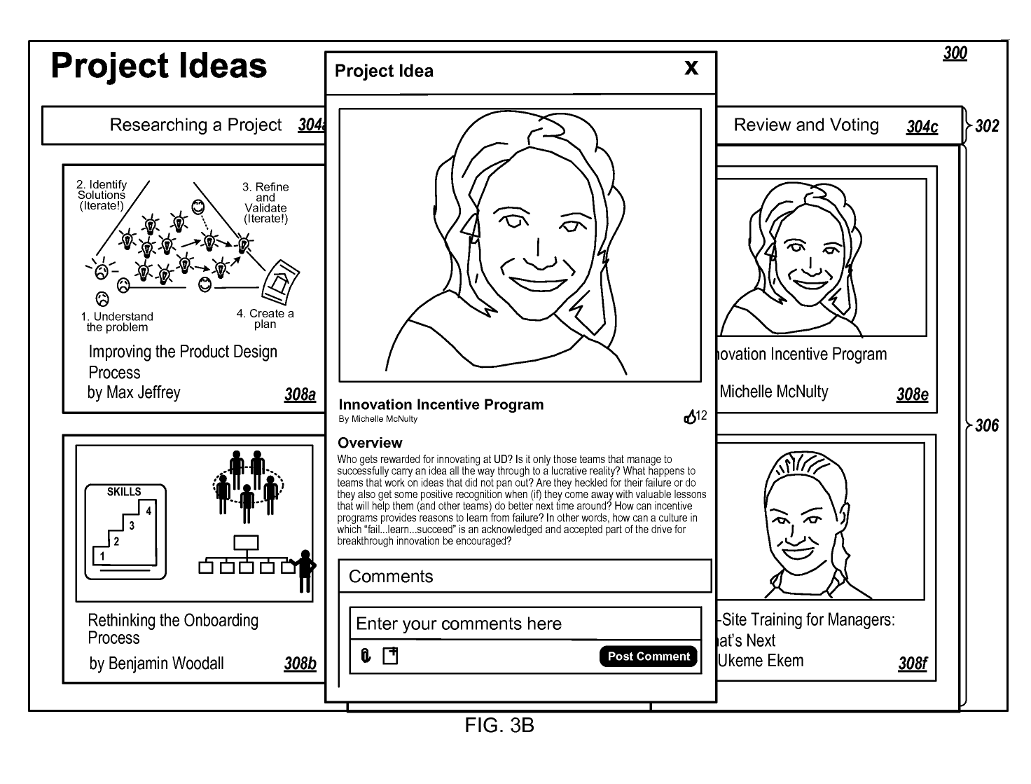

FIGS. 3A-B show an example of another project planning user interface.

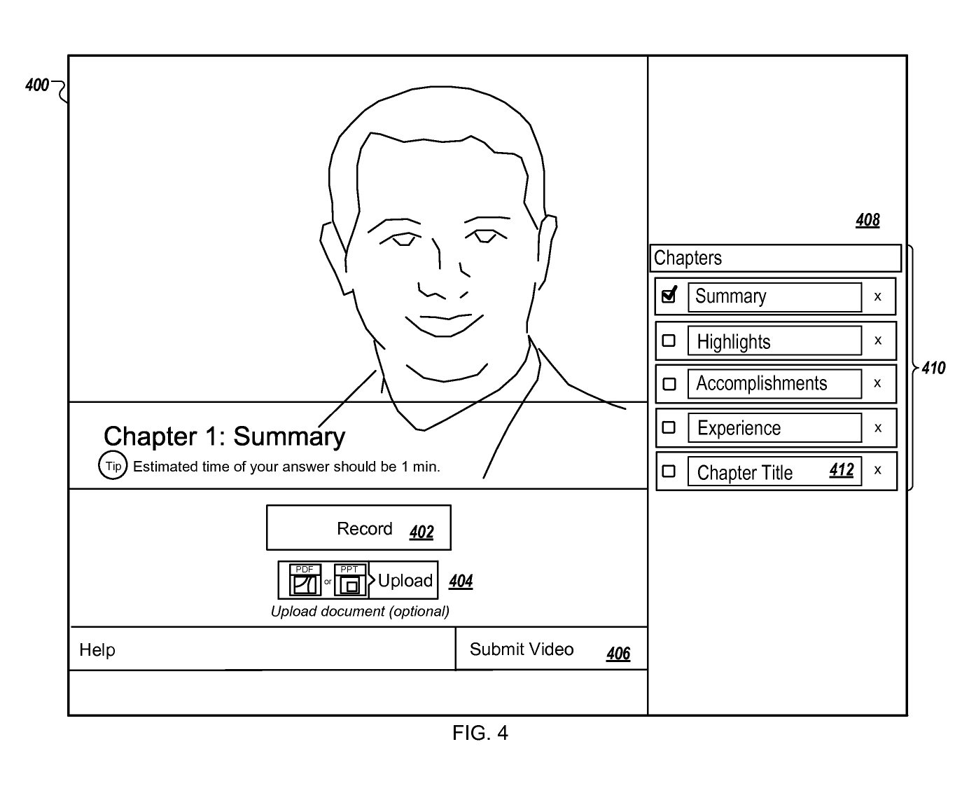

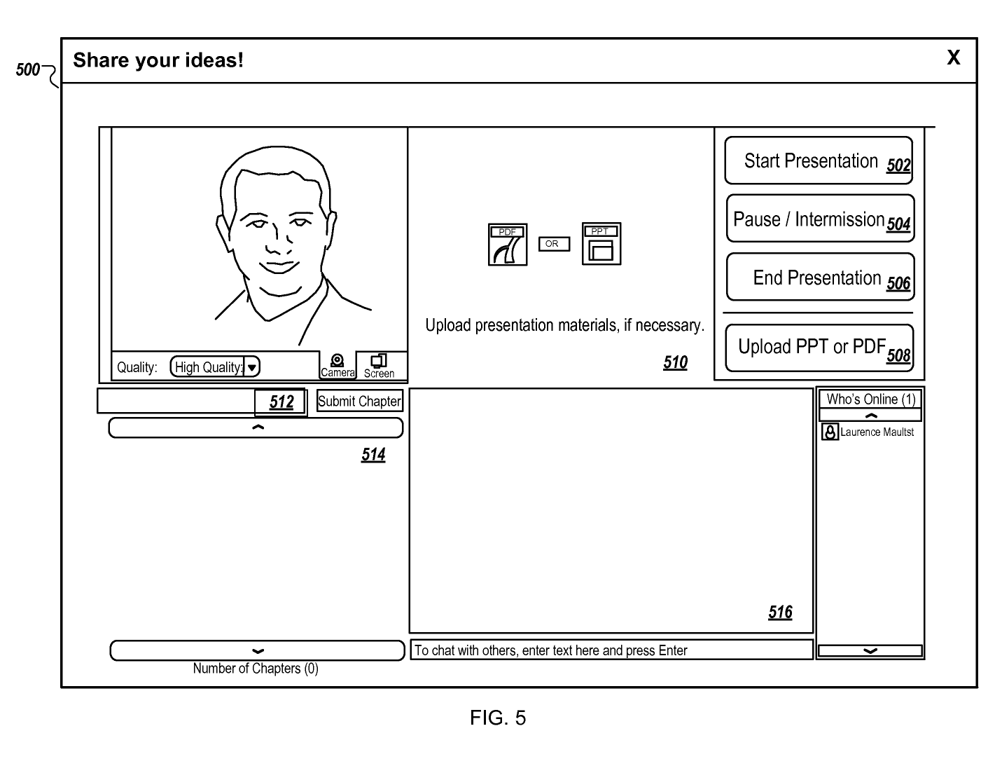

FIGS. 4 and 5 are examples of video submission user interfaces.

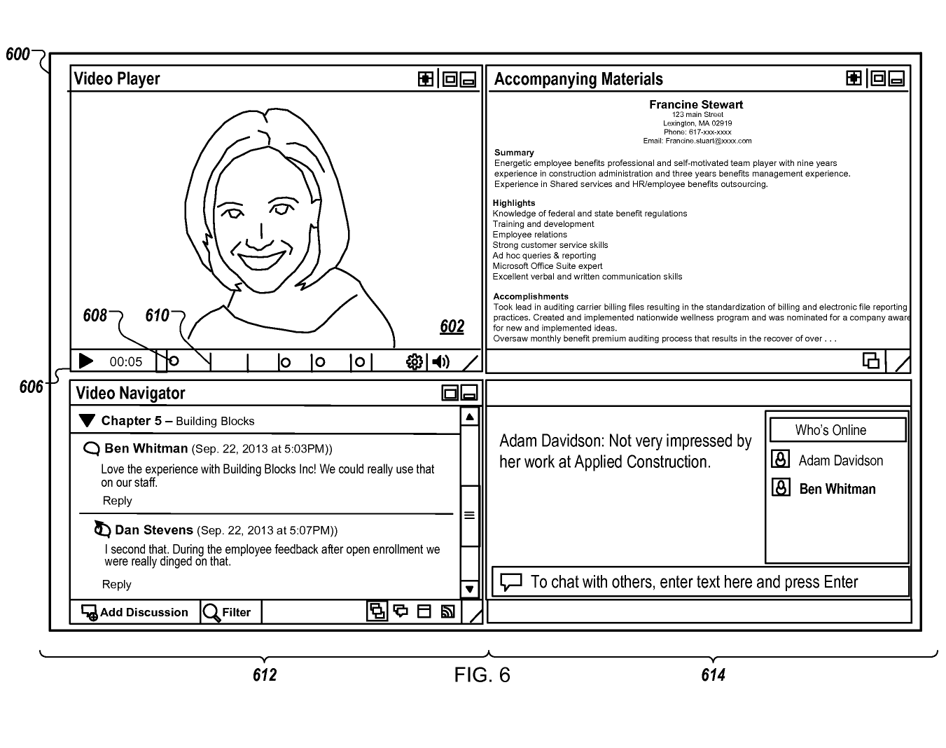

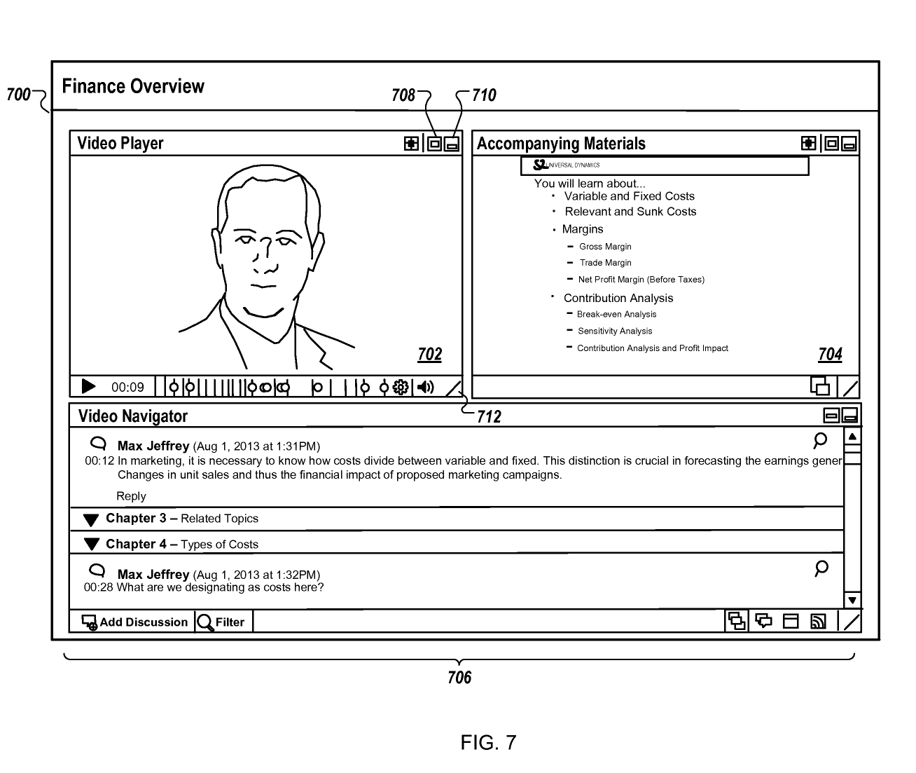

FIGS. 6 and 7 show examples of coordinated presentation user interfaces.

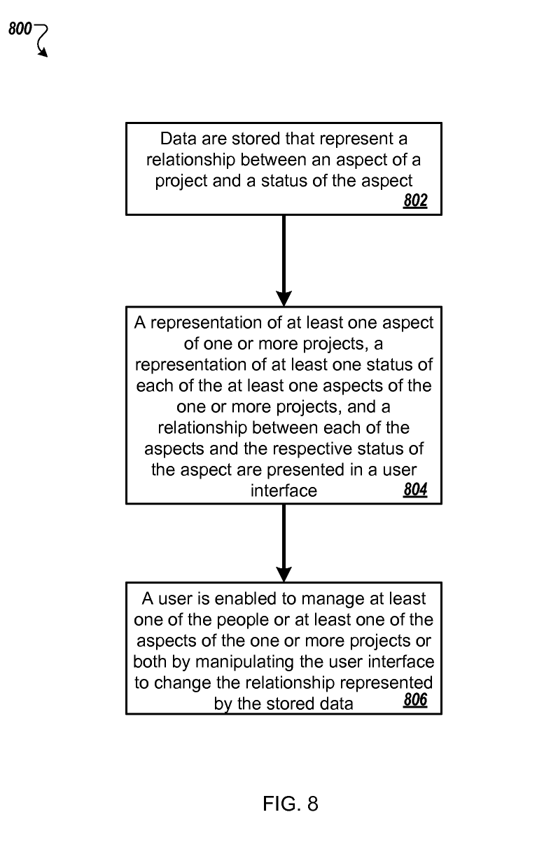

FIG. 8 is a flow diagram.

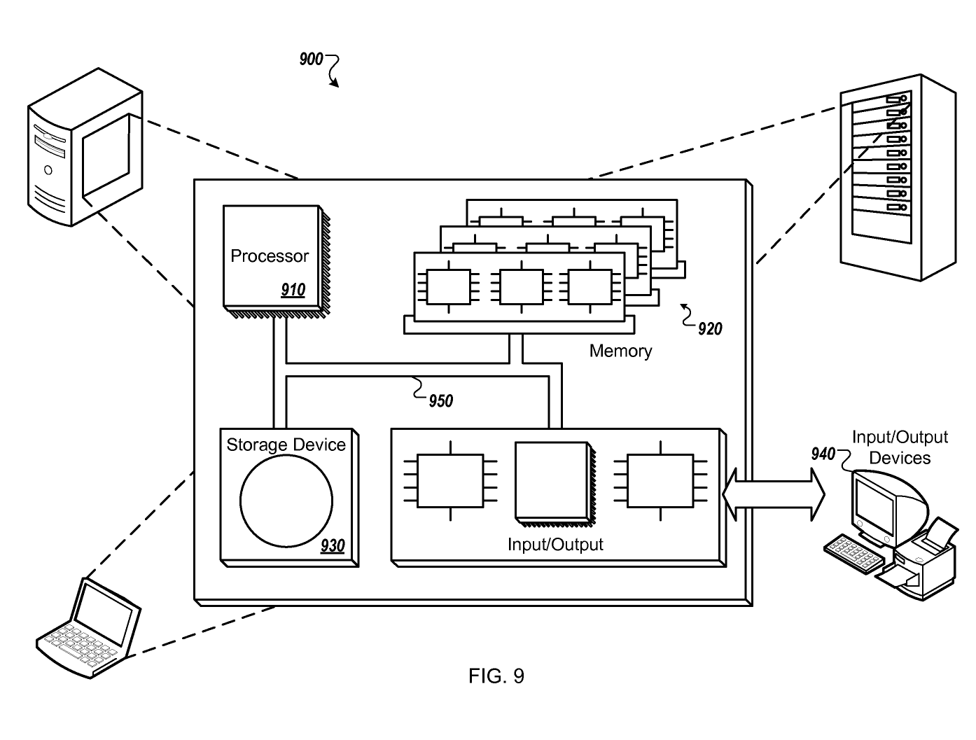

FIG. 9 is a block diagram of an example computer system.

FIGS. 1A-B show an example of a project planning user interface 100 that, among other things, enables users to view tasks to which they are assigned, change task assignments, and change priorities of tasks.

We use the phrase project planning (or project planning and implementing) broadly to include, for example, any kind of project management activity by any kind of user and hosted by any kind of party, e.g., allocation of people and resources to a project of an organization or entity, project or idea submission, and other stages of project development and execution.

We also use the term task broadly to include, for example, any kind of activity or aspect that is associated with a project, for example any activity or aspect of a project that needs to be accomplished for the completion of a project; a project may include one or more tasks. A task may be divided into subtasks that identify steps or portions of a corresponding activity that can be completed separately, in series or parallel, by any kind of task executor with respect to any kind of organization or entity.

The project planning may be performed by an entity or person as part of a wide variety of functions, strategies, and goals, for example, a talent management activity. A project planning activity may be performed an entity or person during the course of working for another entity, such as an organization, a company, or a business. Some examples of projects may include a software development project, a business development project, an engineering project, a talent management project, and a construction project.

The planning and implementing of a project can include a variety of stages or phases. For example, a project submission phase may include the submission of ideas for one or more projects. The ideas may encompass alternatives for a specific task required to complete a project, e.g., different ways to implement the specific task. The ideas may encompass projects that an entity can consider for further planning and implementing, as described in more detail below, and the entity may choose to proceed with planning or implementing or both one or more of the projects encompassed by the ideas, but not all of them, e.g., depending on available budget or other resources or on a strategic or tactical decision by management of the entity.

In some implementations, the project planning user interface 100 shown in FIG. 1A can be populated, organized, and presented in a way that is specific to a particular kind of project, such as a business development project. In that example, the user interface 100 can include employee name labels 102a-c for corresponding employees A, B, and C of an entity or organization. The project planning user interface 100 includes task labels 104a-j which represent the tasks assigned to the employees A, B, and C. For instance, FIG. 1A shows that employee A is assigned to work on task iii, task i, task v, and task x.

The order of the presentation of the tasks labels 104a-d (in this case, vertically from top to bottom) may represent a priority of the tasks for each of the employees, or may be determined using a date on which the corresponding task was assigned to the respective employee. For example, when the employee A views the project planning user interface 100, the employee A may determine that she should work on and complete task iii before starting work on task i. A wide variety of other approaches could be used to organize and display the tasks to signal to a viewer various aspects of the relationships of the tasks and the relationships between the tasks and the employees assigned to the tasks.

A task label may identify the name of the corresponding task, such as “reduce part costs” or “identify areas for improved efficiency.” The task labels may include images, video content or links to video content, e.g., describing the task, or other types of content in addition to or instead of character strings while allowing a user of the project planning user interface 100 to identify the different tasks assigned to the employees A, B, and C.

Similarly, the employee labels 104a-c may include content in addition to or instead of the respective employee's name. The employee labels 104a-c may include a picture, or an icon representing a picture, of the corresponding employee, or video content or a link to video content, e.g., of the respective employee describing her contribution to the project or the types of projects on which she has worked.

By enabling the user to manipulate labels graphically on the user interface 100, the user interface 100 allows the user to change the identification of tasks, the relationship among them, the relationship among tasks and employees, and the relationships among employees, and combinations of any two or more of those effects.

For example, a user of the project planning user interface 100 may reassign a task from one employee to another by graphical manipulation. For instance, at time T₀, the user may drag the task iii label 104a from a column for the employee A to another column for the employee C, as shown in FIG. 1A, to change the assignment of the task iii from employee A to employee C. The project planning user interface 100 then presents the task iii label 104a in the column for the employee C at time T₁, as shown in FIG. 1B. Dragging of the task iii label 104a in this way not only graphically illustrates a new relationship among the tasks and the employees, but it can cause relationships of data in a database to be changed so that they represent the new relationship instead of the original relationship. Then the changed data in the database can be used for other purposes.

Separately, or in combination with moving a task to a different column, the user may change a priority of one of the tasks in the project planning user interface 100 by dragging the corresponding task label to another position in the same employee column. For example, at time T₀ the user may move task iv label 104g to a new position above task iii label 104f, as shown in FIG. 1A, to indicate that task iv is now to have a higher priority for employee B than task iii label 104f, as shown at time T₁ in FIG. 1B.

When a user moves a task label from one column to another, the user may change the priority of the task. For example, task iii has a highest priority for employee A at time T₀. When task iii is assigned to employee C, as shown in FIG. 1B, the task may have a second highest priority, a lowest priority, or another priority level.

More than one employee may be assigned to work on a given task. The same task may have different priorities for different employees. As shown in FIG. 1A, task iii has the highest priority for employee A while the same task iii has a second highest priority for employee B.

A system that generates the project planning user interface 100 may use any appropriate method to determine and assign priority levels to tasks. For example, the system may assign a priority to a task using the date that the task was created, e.g., such that a task created on an earlier date will have a higher priority than a task created on a later date, or using a deadline for the task, e.g., such that a task with an earlier deadline will have a higher priority than a task with a later deadline. In some examples, the system may receive priority information from multiple users, each of which view and interact with the project planning interface 100 separately.

The tasks may have corresponding numerical priority scores, alpha numeric priority scores, decimal priority scores, or another type of priority score, or any combination of two or more of those. The priority scores may be defined by a user of the project planning user interface 100, e.g., a manager of the employees A, B, and C, or the employee A (for example) may assign priorities to her own tasks.

The system may identify one or more rules that apply to the presentation of labels in the user interface 100, for one or more of the employees or tasks, prior to or during generation of the project planning user interface 100. A rule may indicate that labels that represent people or tasks with particular attributes should be highlighted, such as task xiii label 104j, or only people or tasks with particular attributes should be presented in the project planning user interface 100, such as employees A, B, and C but not employees D and E. The rule may be defined by the corresponding employee, e.g., employee C for the task xiii, or another person who views the project planning user interface 100, e.g., a manager of the employee C or a manager of all the employees A, B, and C.

The system may apply the rules using the title of the task, a description of the task, a task status, a task deadline, a combination of employees who are assigned to particular tasks, or combinations of any two or more of those. For example, tasks that are only assigned to one employee may be highlighted, e.g., task xiii. Tasks that are assigned to a particular group of employees, e.g., task iii, may be highlighted. When task iii is reassigned from employee A to employee C, a particular type of highlighting of the task may remain the same as shown in FIGS. 1A-B, e.g., when all tasks assigned to a group of employees are highlighted, may change, e.g., when the highlighting is specific to particular employee groups, or may be removed.

The highlighting of a task, e.g., task iii, may include any appropriate identifier corresponding with the task. The highlighting may distinguish the task from other tasks in the project planning user interface 100, such as all tasks assigned to employee B may have a background that is the employee B's favorite color or another color specified by the employee B. The highlighting may include various types of shading, cross hatching, e.g., the task iii, font or background colors, font styles, or any combination of two or more of those. The system may apply the highlighting to the corresponding label or to an area around the label, e.g., that will not be confused as highlighting another, different label.

Another rule may be a global rule that identifies what types of information may be presented to a particular user in the project planning user interface 100. A global rule may indicate that a user can only view tasks to which they are assigned or employee task assignments for employees who are managed by the user. Another global rule may indicate that tasks with an imminent deadline should be highlighted, e.g., irrespective of the employee to which the task is assigned. For instance, tasks whose deadlines have passed may be outlined in red, tasks whose respective deadlines are in the next week or month may be outlined in yellow, and tasks whose respective deadlines are more than one month away may be outlined in green or have no highlighting.

Some rules may indicate that only tasks with a status of proposed (but not active), planned, active, or complete, should be highlighted or presented in the project planning user interface 100. Some rules may indicate that tasks or projects that are included in a subset of the status types, e.g., proposed and planned or planned, active, and complete, should be highlighted or presented in the project planning user interface 100, while projects with a status type not included in the subset are not highlighted, unless another rule applies to those projects, or not presented at all.

In some examples, the project planning user interface 100 maintains the position of task labels while allowing a user to move employee labels. For instance, a main axis 106 of the project planning user interface 100 may include the task labels while a body 108 of the project planning user interface includes the employee labels. In the example shown in FIGS. 1A-B, the main axis 106 includes the employee labels, e.g., in fixed positions.

In some implementations, a user may move both the task labels 104a-j and the employee labels 102a-c. For instance, the user may switch the employee A column with the employee B column, change the priority of the task iv, and reassign the task iii from the employee A to the employee C.

A user may select one of the employee name labels 102a-b or one of the task labels 104a-j to view additional details for the corresponding person or task. A user interface that presents the additional details may include social features or video features, such as those described in more detail below.

FIG. 2 is a block diagram of an example environment 200 in which a project management system 202 provides information for a project planning user interface to a user device 216a-d upon request. A user device A 216a operated by an employee A may request a project planning user interface to identify project ideas submitted by the employee A or to allow the employee A to submit a new project idea, as described in more detail below.

In response to a request for a project planning user interface with details about one or more project ideas, the project management system 202 identifies information about the requested project ideas 204, e.g., from a database, and provides the information about the requested project ideas to the user device A 216a. The user device A 216a uses the information about the requested project ideas to generate and present the project planning user interface, e.g., as the user interface A 218a. The user interface A 218a may be part of a web browser A 220a or another application on the user device A 216a.

Similarly, the project management system 202 may receive a request for project management data from a user device C 216c and identify project tasks 206 and employee assignments 208, which identify the people assigned to the tasks, specific to a particular project indicated in the request. The project management system 202, or the user device C 216c, may use the requested data to generate a project planning user interface and the user device C 216c presents the user interface as the user interface C 218c for an application executing on the user device C 216c, on the project management system 202, or on both the user device C 216c and the project management system 202, e.g., as a client-server application.

The project tasks 206 and the employee assignments 208 may be stored in a single database on the project management system 202. For instance, the database may store records for each task that indicate the employees assigned to work on the respective task. In some examples, a first database stores an identifier, and optionally a description, for each of the project tasks 206 and a second database associates the project tasks with the employees assigned to work on the tasks.

The project ideas 204 may be stored in the same database as the project tasks 206, the employee assignments 208, or both, or in another database. In some implementations, the employee assignments 208 indicate particular employees who are assigned to work on particular projects, in addition to or instead of tasks for the particular projects. In these implementations, the project management system 202 may provide data for data for a project planning user interface for multiple projects instead of or in addition to multiple tasks for those projects.

When the project management system 202 receives an indication that one or more user interface elements or representations in the project planning user interface have been moved or otherwise changed, the project management system 202 updates the corresponding data in the project ideas 204, the project tasks 206, the employee assignments 208, or data for any combination of two or more of the data types, e.g., in a single database or multiple databases.

The project management system 202 may identify one or more presentation rules 210 for a project planning user interface. As discussed above, the presentation rules may specify user defined rules that indicate particular tasks, projects, or employees that should be highlighted or the types of data available to be presented in a user interface to particular users.

Each of the project ideas 204, project tasks 206, projects, or employees may be associated with video data 212, chat and comment data 214, or both. As described in more detail below, a user may upload a video presentation that describes one of the project ideas 204 or one of the project tasks 206, such as why a particular project idea should be implemented, how the particular project idea will benefit a company or an employee, the status of a project task, or how to implement a project or project task.

For example, another user, such as a manager D, may request to view video data from the project management system 202, e.g., using the user device D 216d. In response, the project management system 202 identifies the requested video data from the video data 212 and provides the requested video data to the user device D 216d. The user device D 216d presents the requested video data in the user interface D 218d, e.g., which is part of the web browser D 220d or another application.

The chat and comment data 214 may include comments describing one or more of the project ideas 204 or the project tasks 206. For instance, a user viewing a project planning user interface may select a project idea or a task to view detailed information about the project idea or task and provide a comment on the project idea or task, as described in more detail below. The project management system 202 receives data representing the comment and updates the chat and comment data 214 accordingly.

Users may create chat sessions using the project planning user interface and discuss a corresponding project. A chat session may allow the users to share information about the project and view the same information about the project at the same time to facilitate communication about the project when the users are in different physical geographic areas, e.g., different rooms of a building, different cities, or different states. The project management system 202 may store data about the chat sessions in the chat and comment data 214 or not, e.g., depending on settings specified by the users of the project planning user interface.

The user interfaces A-D 218a-d allow the corresponding users to submit data to the project management system 202 in addition to or instead of receiving data from the project management system 202. The user device B may submit data for a presentation rule to the project management system 202. When the project management system 202 determines that the employee B requested a project planning user interface, e.g., with the user device B or another user device, the project management system 202 provides the presentation rule to the requesting user device, applies the presentation rule to the project planning user interface, or applies the presentation rule to data responsive to the request prior to providing the project planning user interface to the requesting user device.

The project management system 202 may receive project ideas, project information, status information, project tasks, employee assignments, e.g., from a manager or another employee, video data, or chat or comment data from one or more of the user devices A-D 216a-d. The data may be received in response to a user changing a location of a user interface element, e.g., a project or task label, presented in the project planning user interface or data received by the project planning user interface in response to user input, e.g., defining a rule. One or more of the user devices A-D 216a-d may include a web browser A-D 220a-d, a custom application, or another type of application to upload data to or access data from the project management system 202.

The user devices 216a-d may include personal computers, mobile communication devices, scanners, and other devices that can send and receive data over a network 222. The network 222, such as a local area network (LAN), wide area network (WAN), the Internet, or a combination thereof, connects the user devices 216a-d and the project management system 202, e.g., one or more servers that perform the operations of the project management system 202 and store the data of the project management system 202 in memory.

FIGS. 3A-B show an example of another project planning user interface 300 that, among other things, enables users to submit and vote on project ideas. The other project planning user interface 300 includes a main axis 302 for different status categories of the project submission process. The status categories shown in FIG. 3A include researching a project 304a, defining a project pitch 304b, and review and voting on projects 304c. Different project planning status categories may be included in project planning user interfaces in other implementations.

A body 306 of the other project planning user interface 300 includes project idea labels 308a-f for each of the submitted project ideas that are each placed in a corresponding status category based on the status of the submitted project idea. The project idea labels 308a-f include an image of a user who submitted the project idea or for the corresponding project idea, a title, and the name of the user who submitted the project idea. The project idea labels 308a-f may include additional information, such as video content or a link to video content, or less information, such as only a title for the project idea.

When a user determines that a status of one of the project ideas has changed, the user may select the corresponding project idea label 308a-f and move the project idea label to the appropriate status category column, similar to the process described above with reference to FIGS. 1A-B. For instance, a user may move a project idea label from one column to an adjacent column on the right to indicate the change to the status of the respective project idea, e.g., from proposed to planned, from planned to active or from active to complete.

The other project planning user interface 300 may determine whether a user has permissions to change the status of a particular project idea. A system may allow only the user who submitted a particular project idea, that user's manager, all managers to change the status of the particular project idea, or any combination of two or more of these.

In some implementations, the other project planning user interface 300 is customized based on the user or user device that requested the other project planning user interface 300. For instance, when a system provides the other project planning user interface 300 to a manager, the other project planning user interface 300 may include project ideas for managers, such as an “Inspiring Team Members through Gamification” project idea and an “On-Site Training for Managers: What's Next” project idea that are not included in a user interface presented to an entry-level employee.

Selection of one of the project idea labels 308a-f presents a project details user interface 310, shown in FIG. 3B. The project details user interface 310 may be presented next to or overlay all or a portion of the other project planning user interface 300.

The project details user interface 310 includes an image 312 of the employee who submitted the project idea, an overview 314 describing the project idea, and a comments interface 316 that allows users to submit and view comments for the project idea and upload files related to the project idea. Other implementations of the project details user interface 310 may include more or less information.

The files a user may include a video presentation of a presenter describing the project idea, some of the benefits of the project idea, or how to implement the project idea. The presenter may be the person who submitted the project idea or another user. The video presentation may be submitted by selection of an upload file option 318 or through one of the video submission user interfaces described in more detail below.

The project details user interface 310 may include a live chat option that allows different users who are viewing information about the same project idea or different project ideas to communicate. For instance, the project details user interface 310 may include a section for presentation of a coordinated presentation that includes a live chat option, as described in more detail below.

In some implementations, additional details may be available for particular project ideas and not others. The additional details may be accessible based on the status of the respective project or project idea. For example, a user may not be able to view additional details for a project idea that is currently being researched but may contact the person who submitted the project idea to collaborate on the project idea, while additional details are available for project ideas with a pitch that is being defined or that are open for review and voting.

One or more projects that are being defined may include additional details available to a user of the other project planning user interface 300. The user may view the additional details and provide a submitter of the project idea with feedback that the submitter may use to refine her project idea prior to completion of the project idea. In some examples, when the user of the other project planning user interface 300 submitted a particular project idea, that user may view additional details about the particular project idea while other users cannot view any additional details or have fewer additional details about the project idea presented to them in the project details user interface 310.

When a project idea is completed, or substantially completed, and is ready for review and voting, the project details user interface 310 may include a rating option that allows users to submit a rating score for the project idea. The rating score may be a binary score, e.g., like or don't like, or a ranged score, e.g., one to five stars.

Upon completion of a voting period, a system may aggregate the scores received from various users to determine an overall score for the project idea. The scored project ideas may be presented in another column in the other project planning user interface 300 and may be ranked in a user interface using the aggregated score.

The system, a user, or an organization may then select one of the scored project ideas, using the corresponding score, such as a highest scoring project idea, or arbitrarily, for implementation. The project ideas may be class project ideas for a school, college, or university, or project ideas for a volunteer group or a church.

Details for the project selected for implementation may be presented in the project planning user interface 100, shown in FIG. 1. For instance, the other project planning user interface 300 may be used to select a project to implement and the project planning user interface 100 may be used during implementation of the selected project.

FIG. 4 is an example of a video submission user interface 400 that may be presented to a user as part of a project idea submission or review process or during project management. The video submission user interface 400 may include an upload document option 404. Once a document is uploaded to the project management system, an image 408 of the document is presented in the video submission user interface 400.

The user may select a record option 402 to initiate a capture of a presentation of the user describing the uploaded document, e.g., a project idea, task, or task status description. While the user is recording the video, related portions of the uploaded document may be displayed or identified (either automatically or by the user) in the video submission user interface 400. For example, the user may change the portion of document represented by the image 408 during the capture of the video presentation, e.g., by scrolling through the document, and the project management system or a user device controlled by the user may synchronize (that is, track the timing within) the presentation of the document with the video presentation by the user.

For instance, the user device operated by the user may receive a synchronization engine from the project management system, e.g., with instructions for the presentation of the video submission user interface 400 or as part of a custom project idea submission application, that synchronizes the captured video presentation with a presentation of the image 408 in the video submission user interface 400. Using the tracking information, the corresponding portions of the uploaded document can be displayed in synchrony with the corresponding portions of the video during later playback of a coordinated presentation. Once the capture and synchronization of the video presentation with the document presentation are complete the user device provides the coordinated presentation to the project management system, e.g., in response to a user selection of a submit video option 406.

In some examples, the user device may provide video information representing a recording of the video presentation as a stream of content directly to the project management system. While the project management system receives video information capturing the presentation by the user describing her project idea, the synchronization engine, at the project management system, synchronizes the captured video presentation with the portions of the document presented in the video submission user interface 400.

The synchronization of the captured video presentation with the portions of the document allows the project management system to provide a coordinated presentation, described in more detail below, that includes the captured video presentation and the document, in another user interface. The other user interface may be presented on another user device, for instance controlled by a project manager at an entity, e.g., a company, a business, or an organization. The other user interface may be included in a web browser or another application, e.g., that allows the project manager to view submitted project ideas or perform project management tasks.

After selection of the record option 402, the video submission user interface 400 presents a stop option that, upon selection, stops the recording of the video presentation. The user may then submit the video presentation with selection of the submit video option 406. In some examples, selection of the submit video option 406 may provide a project management system with other files in addition to a coordinated presentation. For instance, the video submission user interface 400 may be presented to the user as a final interface during a project idea submission process and the project management system may receive other files or documents related to the project idea that are submitted to the project management system with the coordinated presentation.

Prior to submission, a user may synchronize the presentation of the video with the presentation of the image 408 of the document, e.g., if the project management system or the device controlled by the user does not automatically perform the synchronization or to supplement a synchronization. For example, the user may create chapters 410 for the video presentation, using a create chapter option 412, and indicate which portions of the document should be presented for each of the chapters 410 in the video presentation. The user device controlled by the user or the project management system may use any appropriate method to synchronize the video presentation with the document presentation.

The user may view the coordinated presentation that includes both the video presentation and the document presentation prior to submission, e.g., before the device controlled by the user provides the project management system with the coordinated presentation or, when the project management system receives a video stream from the user's device, before the user finalizes the submission process. The video submission user interface 400 may include an option for the user to initiate a new recording of the video presentation, create multiple separate video presentations for different portions of the document or different chapters, or remove a portion of the video presentation, in addition to submitting the coordinated presentation to the project management system with selection of the submit video option 406.

FIG. 5 is an example of another video submission user interface 500. An upload document option 508 allows a user to select a document, such as a presentation document, to upload to the project management system. The user may initiate a capture of a presentation describing the uploaded document with a start presentation option 502, and may pause or end the capture with a pause option 504 and an end option 506, respectively. As with the video submission user interface 400, the user may change the content of the document presented in a preview window 510 during the presentation and the project management system, or a device controlled by the user, may synchronize the video presentation with the document presentation.

The video submission user interface 500 includes a create chapter option 512 which adds a new chapter to a chapter list 514 for the video presentation. During later playback of a coordinated presentation, created from the video presentation and the document presentation, a user may select one of the chapters to jump to a corresponding location in the video presentation and document presentation.

A chat interface 516 may allow the user to initiate conversation with another user. For instance, when the user submits a project idea the user may initiate a conversation with their manager to discuss a question, e.g., about the submission process or the project idea.

The video submission user interface 400 or the other video submission user interface 500 may be used to submit a video presentation without the submission of a document. For example, a user may describe their project, project idea, or task in the video presentation without providing supplemental information in a document. The description by the user may correspond with questions the user answers as part of a project idea submission process.

FIG. 6 shows an example of a coordinated presentation user interface 600 that may be presented to a manager, an employee, or another user in response to selection of a task label, an employee label, a status label, a project label, or a project idea label. The coordinated presentation user interface 600 may present a video presentation 602 and a document preview 604. The document preview 604 may include questions, e.g., for a project idea submission process, or a document or file submitted by a person. The content presented in the document preview 604 may change during the coordinated presentation, e.g., based on the currently presented portion of the video presentation 602 or chapter of the coordinated presentation.

The coordinated presentation user interface 600 includes a video navigation bar 606 which allows a person to cause the display of different portions of the video presentation 602. The video navigation bar 606 includes comment identifiers 608 and chapter identifiers 610 that indicate the time at which a person created a comment, e.g., in a chapter panel 612, and the start and stop times for the chapters. The video navigation bar 606 may include a forward option and a backward option that cause the coordinated presentation to change to the time associated with the next comment, or chapter. In some examples, the forward option and backward option may move the presentation between either comments or chapters, but not both.

A person may enter a comment in response to a statement made by the presenter or a portion of the document in the document preview 604. The chapter panel 612 may allow people to reply to comments, edit comments, delete comments, or create new comments. The chapters in the chapter panel 612 may correspond with different tasks for a project, or an overview of a project and how the project will be implemented. For example, some chapter names may include “Summary,” “Problem,” “Solution,” and “Implementation” indicating separate portions of a project idea submission.

The coordinated presentation user interface 600 includes a live chat option 614 that allows people who are viewing the same coordinated presentation, e.g., the same portion of the presentation or different portions, to discuss the presentation, e.g., project idea, task, or project. The live chat option 614 may allow a person to send another person a link to a specific portion of the video presentation 602 which the person is viewing, e.g., to allow both people to discuss the specific portion of the video presentation 602.

In some examples, the live chat option 614 may allow people viewing different coordinated presentations, or who are both using a chat interface, to interact. For instance, a user device presenting the coordinated presentation user interface 600 may send a link for a particular coordinated presentation to another user device presenting a chat interface, i.e., but not the coordinated presentation user interface 600. Selection of the link on the other user device may cause an application to present the coordinated presentation user interface 600 on the other user device and the presentation of the particular coordinated presentation.

FIG. 7 is another example of a coordinated presentation user interface 700. The coordinated presentation user interface 700 includes a video presentation 702, a document preview 704, and a chapter panel 706 with comments. A person may interact with the coordinated presentation user interface 700 to move or adjust the size of any of the elements included in the coordinated presentation user interface 700, e.g., the video presentation 702, the document preview 704, or the chapter panel 706. For instance, each element may include a maximize option 708, a minimize option 710, and a resize option 712. Similarly, a person may interact with the coordinated presentation user interface 600 to adjust the size or position of any of the elements in the coordinated presentation user interface 600, e.g., the video presentation 602, the document preview 604, the chapter panel 612, or the live chat option 614.

FIG. 8 is a flow diagram of an example process 800 for enabling a user to manage aspects of a project or people assigned to the project. For example, the process 800 can be carried out by the project management system 202 from the environment 200 shown in FIG. 2.

Data are stored that represent a relationship between an aspect of a project and a status of the aspect (802). The project management system may store the data in a database or multiple databases. The data may include data for project ideas, project descriptions, descriptions of one or more aspects, e.g., tasks, necessary to complete a project, assignments that indicate relationships between people assigned to work on a project and the aspects of that project, a status of each of the project's aspects, presentation rules for a project, a task, a project idea, a person, an organization, an entity, or a group of people, or any combination of two or more of those.

A representation of at least one aspect of one or more projects, a representation of at least one status of each of the at least one aspects, and a relationship between each of the aspects and the respective status of the aspect are presented in a user interface (804). The representations may include labels, such as an employee name label, a project or task label, or a status label. Each of the representations is graphically associated with a representation of a different type in the user interface and this graphical association indicates a relationship between the two corresponding representations.

For example, the user interface may include a grid with the project labels and the status labels such that the rows or columns of the grids identify a relationship between the project labels and the status labels that are positioned in the same row or the same column. The status labels may be included in a header in the grid, e.g., and remain in the same position, and may indicate respective statuses of: researching, defining, and proposed; proposed, planned, and active; proposed, planned, active, and complete; one of the status categories described with reference to FIGS. 3A-B; another progress status; or a combination of statuses described here or other status labels. Some or all of the status labels may identify a person assigned to a project or a person assigned to a task represented by a corresponding project label.

The project labels identify different projects actively managed by the organizations or entities, proposed for implementation by the organizations or entities, or aspects of particular projects. The project labels may include a name of the corresponding project or task. In some examples, the project labels include details of the corresponding project or task and selection of the project label, e.g., by double clicking on the project label, may cause a presentation, e.g., by the project management system, of additional details, social features, video features, or any combination of two or more of those for the corresponding selected project or task.

A user is enabled to manage at least one of the people or at least one of the aspects of the one or more projects or both by manipulating the user interface to change the relationship represented by the stored data (806). For example, when the status labels remain in the same position, the project labels may be moved throughout separate rows or columns represented by the status labels in the grid, e.g., to allow the user to manage the aspects represented by the project labels or to manage the people by changing the project aspects assigned to the people. In some implementations, the project labels may remain in the same position, e.g., in a row or column header, while the status labels are moved throughout the grid. In some examples, a user may change the position of both the status labels and the project labels to change a relationship for the moved status labels or the moved project labels. When the user changes the position of a header label, for a row or a column, the other labels in the corresponding row or column may move with the header label or may remain in the same position.

The order of steps in the process 800 described above is illustrative only, and enabling the user to manage aspects of the project or people assigned to the project can be performed in different orders. For example, the data is stored, e.g., step 802, while the user interface is presented, e.g., step 804, and the user interface is presented to a user, e.g., step 804, while the user is enabled to manage the people, the aspects, or both, e.g., step 806.

In some implementations, the process 800 can include additional steps, fewer steps, or some of the steps can be divided into multiple steps. For example, the project management system may update the stored data in response to the user manipulating the user interface to change the relationship represented by the stored data.

FIG. 9 is a block diagram of an example computer system 900. For example, referring to FIG. 2, the project management system 202 or a server forming a portion of the project management system 202 could be an example of the system 900 described here, as could a computer system used by any of the users who access resources of the project management system 202, e.g., the user devices 216a-d. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In some implementations, the processor 910 is a single-threaded processor. In some implementations, the processor 910 is a multi-threaded processor. In some implementations, the processor 910 is a quantum computer. The processor 910 is capable of processing instructions stored in the memory 920 or on the storage device 930. The processor 910 may execute operations such as receiving or maintaining information that identifies one or more projects (FIG. 8).

The memory 920 stores information within the system 900. In some implementations, the memory 920 is a computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a computer-readable medium. In various different implementations, the storage device 930 can include, for example, a hard disk device, an optical disk device, a solid-date drive, a flash drive, magnetic tape, or some other large capacity storage device. In some implementations, the storage device 930 may be a cloud storage device, e.g., a logical storage device including multiple physical storage devices distributed on a network and accessed using a network. In some examples, the storage device may store long-term data, such as the project ideas 204, as well as the project tasks 206 and the employee assignments 208 (FIG. 2). The input/output device 940 provides input/output operations for the system 900. In some implementations, the input/output device 940 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. A network interface device allows the system 900 to communicate, for example, transmit and receive data such as the project ideas 204, and/or identification of the project tasks 206 or the employee assignments 208 shown in FIG. 2. In some implementations, the input/output device can include driver devices configured to receive input data and send output data to other input/output devices, e.g., keyboard, printer and display devices 960. In some implementations, mobile computing devices, mobile communication devices, and other devices can be used.

A server (e.g., a server forming a portion of the project management system 202 shown in FIG. 2) can be realized by instructions that upon execution cause one or more processing devices to carry out the processes and functions described above, for example, sending and receiving the project ideas 204, and/or identification of the project tasks 206 or the employee assignments 208 (FIG. 2). Such instructions can include, for example, interpreted instructions such as script instructions, or executable code, or other instructions stored in a computer readable medium. A project management system 202 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 9, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for creating and maintaining the project ideas 204, and/or identification of the project tasks 206 or the employee assignments 208 (FIG. 2), can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of a project management system 202) is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A method comprising:
for an organization or entity that engages in projects through people who are associated with the organization or entity, each of the people or the projects or both being managed by users who are also associated with the organization or entity:
presenting through a user interface a representation for each of at least one project idea, another representation of a status of each of the project ideas, and a relationship between each of the project ideas and the corresponding status of the project idea, the relationship being represented by stored data, each project idea being submitted by at least one of the people; and
enabling one of the users to change the status of at least one of the project ideas by manipulating the user interface to change the relationship represented by the stored data.

2. The method of claim 1 in which the stored data identifies project ideas that are proposed but not active.

3. The method of claim 1 comprising receiving, for at least one of the project ideas, a rating of the corresponding project idea.

4. The method of claim 3 comprising ranking at least some of the project ideas using the corresponding ratings, and in which presenting through the user interface the representation for each of the at least one project idea, the other representation of the status of each of the project ideas, and the relationship between each of the project ideas and the corresponding status of the project idea comprises presenting a representation of a project idea for each of two or more of the ranked project ideas according to the ranking.

5. The method of claim 3 comprising aggregating, for at least one of the rated project ideas, the corresponding ratings.

6. The method of claim 1 in which the stored data identifies the status for each of the project ideas.

7. The method of claim 1 in which presenting through the user interface the representation for each of at least one project idea, the other representation of the status of each of the project ideas, and the relationship between each of the project ideas and the corresponding status of the project idea comprises presenting the representations and the other representations in a grid, the columns or the rows of which identify the relationships between each of the project ideas and the corresponding statuses of the project ideas.

8. The method of claim 7 in which enabling the one of the users to change the status of at least one of the project ideas by manipulating the user interface to change the relationship represented by the stored data comprises enabling the user to move at least one of the representations or at least one of the other representations from one cell of the grid to another cell of the grid within the user interface.

9. The method of claim 7 in which presenting the representations and the other representations in the grid comprises presenting the representations and the other representations in the grid in which a position of each of the other representations of the statuses remains constant while enabling the one of the users to dynamically change a position of at least one of the representations of aspect project idea.

10. The method of claim 1 in which the stored data is stored in a database, the method comprising:
receiving indication of a change to the stored data by the one of the users; and
automatically updating the stored data in the database in response to receipt of the indication of the change to the stored data by the one of the users.

11. The method of claim 1 in which:
a position of one of the representations, with respect to another representation in the user interface, indicates a priority of the corresponding representation; and
enabling the user to change the status of at least one of the project ideas by manipulating the user interface to change the relationship represented by the stored data comprises enabling the user to change the priority of the corresponding representation by moving the corresponding representation within the user interface.

12. The method of claim 1 comprising identifying a subset of the project ideas that are assigned to the user, and in which presenting through the user interface the representation for each of at least one project idea, the other representation of the status of each of the project ideas, and the relationship between each of the project ideas and the corresponding status of the project idea comprises presenting only the representations and the other representations for the identified subset of the project ideas.

13. The method of claim 1 comprising receiving, from the user, identification of one or more rules for the projects, and in which presenting through the user interface the representation for each of at least one project idea, the other representation of the status of each of the project ideas, and the relationship between each of the project ideas and the corresponding status of the project idea comprises applying the rules to the representations or the other representations and presenting the representations and the other representations to which the rules have been applied.

14. The method of claim 13 in which one of the rules excludes at least one of the representations or one of the other representations from the user interface.

15. The method of claim 13 in which one of the rules distinguishes at least one of the representations or one of the other representations from the remaining representations.

16. The method of claim 1 comprising:
receiving selection of one of the representations or one of the other representations; and
presenting additional details about the corresponding project idea that corresponds to the selected representation or the corresponding status that corresponds to the selected other representation.

17. The method of claim 16 comprising enabling the user to invoke social features for the corresponding project idea or the corresponding status.

18. The method of claim 17 in which enabling the user to invoke social features comprises enabling the user to communicate with another user about the corresponding project idea or the corresponding status.

19. The method of claim 16 comprising enabling the user to invoke video features for the corresponding project idea or the corresponding status.

20. The method of claim 19 in which enabling the user to invoke video features comprises receiving, from a device operated by the user or a party other than the user, video information capturing a video presentation about the corresponding project idea or the corresponding status.

21. The method of claim 19 in which enabling the user to invoke video features comprises providing a video presentation about the corresponding project idea or the corresponding status to the user through a user interface.

22. A method comprising:
receiving project ideas from multiple people, each of the project ideas having a corresponding status;
presenting to a user through a user interface the project ideas in a grid showing project labels identifying the project ideas, the project ideas being grouped by the corresponding status; and
enabling the user to dynamically change the corresponding status of at least one of the project ideas by moving a corresponding project label in the grid.

23. The method of claim 22 in which all of the multiple people are employed by an entity and the project ideas are for the entity.

24. The method of claim 22 in which the user is a manager of the people.

25. The method of claim 22 comprising receiving, from at least one of the people, a rating of one or more of the project ideas.

26. The method of claim 25 comprising ranking at least some of the project ideas using corresponding ratings, and in which presenting the project ideas in the grid comprises presenting the ranked project ideas in the grid according to the ranking.

27. The method of claim 25 comprising aggregating, for at least one of the project ideas, the corresponding ratings received from the people.

28. The method of claim 22 comprising:
receiving selection of one of the project ideas; and
presenting additional details about the selected project idea.

29. The method of claim 28 comprising enabling the user to interact with social features for the selected project idea.

30. The method of claim 29 in which enabling the user to interact with social features comprises enabling the user to communicate with another user about the selected project idea.

31. The method of claim 28 comprising enabling the user to interact with video features for the selected project idea.

32. The method of claim 29 in which enabling the user to interact with video features comprises providing a video presentation about the selected project idea to the user.

33. The method of claim 22 in which receiving at least one of the project ideas comprises:
receiving, from a device operated by the user or a party other than the user, video information capturing a video presentation about the corresponding project idea.
